(19) United States
(12) Patent Application Publication
(10) Pub. No.: US 2016/0246646 A1
(43) Pub. Date: Aug. 25, 2016

(54) METHOD FOR EXECUTING TASKS IN A COMPUTER NETWORK

(71) Applicant: FTS COMPUTERTECHNIK GMBH, Wien (AT)

(72) Inventors: Silviu CRACIUNAS, Wien (AT); Ramon SERNA OLIVER, Wien (AT)

(73) Assignee: FTS COMPUTERECHNIK GMBH, Wien (AT)

(21) Appl. No.: 15/027,126

(22) PCT Filed: Sep. 15, 2014
(86) PCT No.: PCT/AT2014/050205

§ 371 Date: Apr. 4, 2016

(30) Foreign Application Priority Data
Oct. 11, 2013 (AT) A 788/2013

(51) Int. Cl. G06F 9/48

(52) U.S. Cl. CPC G06F 9/4881

(57) ABSTRACT

Method for executing tasks in a computer network, wherein said computer network comprises nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages.

The invention relates to a method for executing tasks in a computer network, wherein said computer network comprises nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages.

Furthermore, the invention relates to a computer network comprising nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages.

In yet another aspect the invention relates to a method for calculating task parameters and/or task schedules in a computer network, wherein said computer network comprises nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages.

The (above stated) method for executing tasks in a computer network according to the invention is characterized in that said tasks are executed on nodes and/or on the at least one starcoupler according to a static task schedule, wherein said task schedule is computed by the following steps:

a) transforming a defined task set to a periodic asynchronous task model (p1), yielding a first quantity of task sets;

b) applying a feasibility test (p2) to the first quantity of task sets obtained in step a) for reducing the number of task sets to a second quantity of task sets (s1), a so-called schedulable task sets (s1), also referred to as feasible task sets;

c) applying a precedence test (p3) to the second quantity of task sets obtained in step b), producing a subset of task sets of the second quantity of task sets, said subset of task sets comprising the so-called compliant task sets (s2);

d) applying a criteria (p4) over the set of compliant task sets (s2), resulting in one task set, a so-called “final” task set (s3) (the one from which the schedule will be generated)

The criteria in step d) can be any criteria (in particular non optimal or optimal). For example, a random pick. It is important that the criteria (p4) allows to reduce the quantity of compliant task sets (s2) to one single task set (s3).

As step d) produces one (final/optimal) task set, this allows a dynamic scheduling algorithm simulator (p5) to produce a static schedule, based on the final/optimal task set (s3), called final/optimal schedule. Applying the dynamic scheduling algorithm to all compliant task sets (s2) and selecting one of the resulting schedules would be very inefficient in the number of operations.

The (above stated) computer network according to the invention is characterized in that said tasks are executed on nodes and/or on at least one starcoupler according to a static task schedule, wherein said task schedule is computed by the following steps:

a) transforming a defined task set to a periodic asynchronous task model (p1), preferably an EDF task model (p1), yielding a first quantity of task sets;

b) applying a feasibility test (p2) to the first quantity of task sets obtained in step a) for reducing the number of task sets to a second quantity of task sets (s1), a so-called schedulable task sets (s1), also referred to as feasible task sets;

c) applying a precedence test (p3) to the second quantity of task sets obtained in step b), producing a subset of task sets of the second quantity of task sets, said subset of task sets comprising the so-called compliant task sets (s2);

d) applying a criteria (p4) over the set of compliant task sets (s2), resulting in one task set, a so-called “final” task set (s3) (the one from which the schedule will be generated)

The criteria in step d) can be any criteria (in particular non optimal or optimal). For example, a random pick. It is important that the criteria (p4) allows to reduce the quantity of compliant task sets (s2) to one single task set (s3).

The (above stated) method for calculating task parameters in a computer network according to the invention is characterized in that

a) transforming a defined task set to a periodic asynchronous task model (p1), preferably an EDF task model (p1), yielding a first quantity of task sets;

b) applying a feasibility test (p2) to the first quantity of task sets obtained in step a) for reducing the number of task sets to a second quantity of task sets (s1), a so-called schedulable task sets (s1), also referred to as feasible task sets;

c) applying a precedence test (p3) to the second quantity of task sets obtained in step b), producing a subset of task sets of the second quantity of task sets, said subset of task sets comprising the so-called compliant task sets (s2);

d) applying a criteria (p4) over the set of compliant task sets (s2), resulting in one task set, a so-called “final” task set (s3) (the one from which the schedule will be generated).

For the sake of easier reading, explanations of features with regard to the disclosure of this document, in particular features of method claims (method for executing tasks, method for calculating task parameters) are also true for the corresponding features of the device claims and vice versa, if not stated otherwise.

Preferred embodiments and/or aspects of the invention are described in the dependent claims as follows, which can be combined freely if not stated otherwise.

Preferably, the method for executing and/or calculating task parameters according to the invention and/or the computer network according to the invention can be additionally characterized in that a dynamic scheduling algorithm simulator (p5), preferably an EDF simulator, more preferably an offline EDF simulator, generates, based on the final task set (s3), a schedule, the so called final schedule.

Preferably, the method for executing tasks and/or calculating task parameters (and/or schedules) according to the invention and/or the computer network according to the invention can be additionally characterized in that in step d) an optimal criteria (p4) is applied over the set of compliant task sets (s2), resulting in one task set, a so called optimal task set (s3). The “optimal criteria” is also referred to as “optimality criteria” within this description. In this case, the optimal task set represents the final task set according to the invention and the final schedule represents the optimal schedule according to the invention.

Preferably, the method for executing tasks and/or calculating task parameters (and/or schedules) according to the invention and/or the computer network according to the invention can be additionally characterized in that the task schedule is computed offline.

Preferably, the method for executing tasks and/or calculating task parameters (and/or schedules) according to the invention and/or the computer network according to the invention can be additionally characterized in that dependencies with TT-messages for those tasks involved in the production or consumption of payload data are considered during the specification of task parameters. The specification of task parameters refers to at least four parameters for each task (period, computation time, offset and deadline). Period and computation time are given based on the TT-task set. Offset and deadline are calculated during the transformation step (p1) based on the dependencies to the TT-messages.

Preferably, the method for executing and/or calculating task parameters (and/or schedules) according to the invention and/or the computer network according to the invention can be additionally characterized in that the static schedule is calculated by taking into account the dependencies of tasks to a network schedule of the computer network.

Preferably, the method for executing and/or calculating task parameters (and/or schedules) according to the invention and/or the computer network according to the invention can be additionally characterized in that the static schedule is calculated by taking into account interdependencies of different tasks. This allows that the task transformation (p1) produces all possible task sets (based on the network dependencies and the TT-task set), step p2 eliminates the unfeasible ones (i.e. non-schedulable) and step p3 eliminates from the feasible task sets (s1) those that do not comply with interdependencies of different tasks (producing s2). Interdependencies refer to execution order constraints imposing precedencies in the execution of one task before another.

Preferably, the method for executing and/or calculating task parameters (and/or schedules) according to the invention and/or the computer network according to the invention can be additionally characterized in that each calculated task parameter from each task set of the compliant task sets (s2) is assigned a function, preferably a time utility function (TUF), evaluating the optimality of each possible parameter value. Each task set of the compliant task sets (s2) can be assigned a utility function, preferably a Time Utility Function (TUF) evaluating the optimality of each possible parameter value.

### BRIEF DESCRIPTION OF THE DRAWINGS

The specific features and advantages of the present invention will be better understood through the following description. In the following, the present invention is described in more detail, in particular with reference to exemplary embodiments (which are not to be construed as limitative) depicted in drawings:

FIG. 1 shows a task set transformation and scheduling process,

FIG. 2 shows a time-interdependence of tasks executing in a runtime system (TT-RTS) and network schedules,

FIG. 3 shows a test-bed setup with a TTEthernet switch and 3 end-system nodes,

FIG. 4 shows an output window displaying the generated TT-RTS schedule and dependent TT-messages,

FIG. 5 shows deadline TUFs for consumer task TT, consuming TT-message m, vs rigidity,

FIG. 6 shows the TT-RTS overhead as percentage of the total run-time in function of the macrotic length on the TMS570 platform,

FIG. 7 shows the difference between TT-RTS and network cycle time [ns],

FIG. 8 shows oscilloscope measurement of maximum jitter between any two end-system nodes in Test-Bed (FIG. 3) and

FIG. 9 shows task set for end-system node TTE-C.

### DETAILED DESCRIPTION OF THE INVENTION

### I. Introduction

Optimal static scheduling of real-time tasks on distributed time-triggered networked systems: Mixed-criticality and high availability distributed systems, like those on large industrial deployments, strongly rely on deterministic communication in order to guarantee the real-time behavior. The time-triggered paradigm—as in TTEthernet—guarantees the deterministic delivery of messages with fixed latency and limited jitter. We look closely at industrial deployments in which production as well as consumption of messages is carried out within software tasks running on distributed embedded nodes (i.e. end-systems). We present an approach to minimize the end-to-end latency of such tasks, respecting their precedence constraints as well as the scheduled communication in an underlying switched TTEthernet network. The approach is based on and validated by a large industrial use-case for which we analyze a test bed implementing our solution.

Industrial applications are becoming increasingly distributed among numerous sub-systems with mixed criticality requirements. Ensuring deterministic communication between often co-existing applications is essential to guarantee safe and high-available deployments demanding tight latency, minimum jitter, and bandwidth guarantees. Time-Triggered Ethernet (TTEthernet [1], SAE AS6802 [2]) incorporates a time-triggered paradigm to the IEEE 802.3 standard enabling deterministic time-critical communication over standard Ethernet. TTEthernet enables the timely transmission of periodic messages (TT-messages) at predefined instants of time. This is achieved by means of a global communication schedule where time windows for each transmission are planned ahead on a hop-by-hop basis.

Despite the deterministic end-to-end guarantees of TTEthernet, scheduled messages often carry software-computed pay-load which is to be generated—or respectively consumed—within the end-system software as close as possible to the message transmission—respectively reception—instant. Failing to do so introduces latency at the software layers and potentially adds jitter between the communicating applications hindering the strong determinism of TTEthernet. Extending the network end-to-end guarantees towards the application layers reduces to scheduling the tasks responsible for the production and consumption of payloads right at the instants when the data is to be transmitted or received, respectively.

In this paper we consider optimality with respect to minimizing the effective end-to-end latencies of communicating end-to-end tasks. To this extend, we present a generalized method constructing optimal static task schedules for the applications running on the end-systems of a multi-hop switched network for which a TTEthernet schedule already exists. Our experience with industrial applications shows that the network schedule is often built and optimized with custom constraints during deployment—generally on-site by the customer—and shall not be modified due to certification processes. Hence, we aim at integrating the end-to-end software services and applications without affecting the overall network schedule.

We show that inter-task as well as network dependencies can be expressed in the form of a constrained optimization problem aiming at minimizing the overall end-to-end latency. Moreover, we show how to generate static schedules using mechanisms from dynamic priority scheduling derived from classical scheduling theory. Our approach is centered on task set transformations to a dynamic task model for which there exist necessary and sufficient feasibility tests that can be incorporated in the optimization criteria. Rather than searching for a final optimal schedule among all possible, we define the optimization problem to find feasible task sets for which the offline execution of the dynamic algorithm constructs an optimal schedule table.

Section II details the overall process highlighting the main contributions of this paper. In Section III we introduce the network and task models along with the real-time run-time system implementing our software-platform. We then discuss the task set transformation and detail the optimization problem generating static schedules (Section IV). Section V presents the application of this approach into a real-world industrial test-bed and summarizes the main results. Finally, Section VI overviews related work and Section VII concludes the paper.

### II. General Process

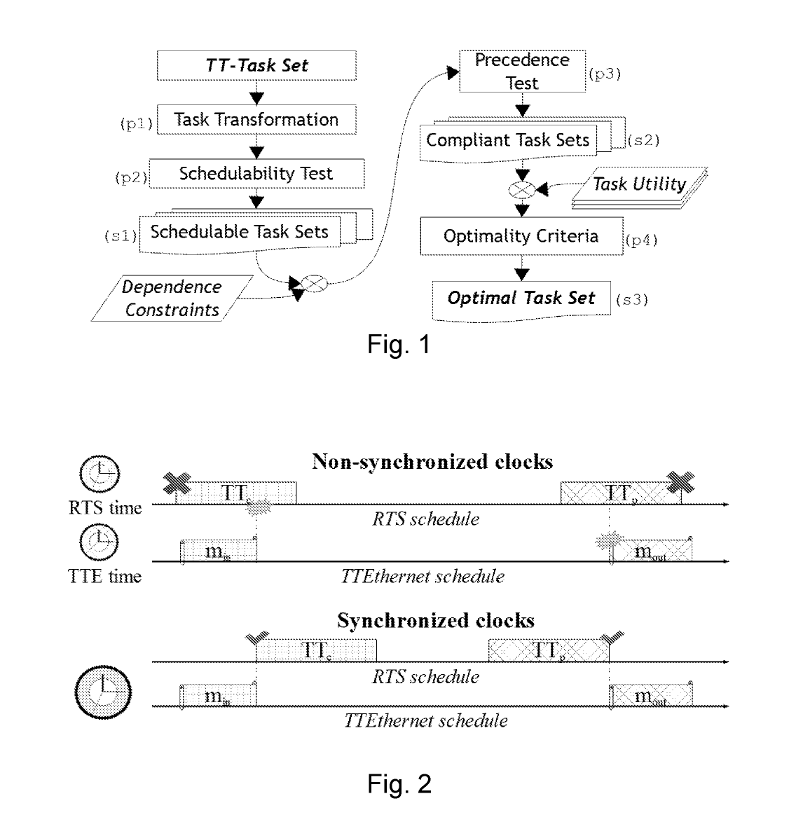

We illustrate the general process building our approach in FIG. 1. The depicted workflow specifies the steps for the generation of an optimal task schedule beginning with the user-defined task set (section III-C) for a given end-system.

The task set is first transformed to a periodic asynchronous task model (p1), preferably an EDF (“Earliest Deadline first”) task model (p1), wherein an EDF is applied to a periodic asynchronous task model.

following the steps in Section IV-A. The dependencies with TT-messages for those tasks involved in the production or consumption of payload data are considered during the specification of task parameters. The transformation yields a large number of task sets due to the combinations of possible values for the new task model, out of which we aim at obtaining the optimal task schedule. However, thanks to the EDF basis we can apply a feasibility test (p2) reducing the search space to those task sets which are feasible under EDF (s1). Note that, as a property of EDF, if a task set does not satisfy its feasibility test no other algorithm would produce a valid schedule. To further reduce the amount of task sets, we apply a precedence test (p3) (Section IV-C) based on the task precedence constraints specified by the user. This produces a subset of compliant task sets (s2) with parameters satisfying the inter-task dependencies.

Next, we apply the optimality criteria (p4) formulated as an optimization problem over the set of compliant task sets, for which each task is assigned a time utility function (TUF) specifying its tolerance towards latency (Section IV-D). As a result, a so-called “final” task set (s3), in particular the feasible task set with the greatest TUF accrual (optimal task set) is found (s3). This task set—if exists—is then sent to an offline EDF simulator (p5) which generates the optimal schedule based on the EDF algorithm (Section IV-E). The output is then processed into a static schedule table that can be used at run-time by our time-triggered run-time system (Section III-B).

This process differs from directly deriving the optimal schedule by means of an optimization search of the complete domain space. Instead, we significantly reduce the work for the optimizer to determining the set of parameters for a feasible EDF task set accounting for the maximum TUF accrual. We then allow an offline EDF scheduler to decide the final placement of task, including their preemptions (i.e. the offline schedule). Moreover, the search space for the optimization problem is further reduced following (p2) and (p3).

### III. System Model

A. Network Model

A key concept of TTEthernet [3] is the time-triggered paradigm enabling real-time and non-real time communication over standard IEEE 802.3 Ethernet. Time-triggered messages (TT-messages) are scheduled periodically at each network device (i.e. switches and end-systems) and transmitted within predefined periodic transmission-windows. Analogously, the reception of TT-messages is only accepted within their reception-windows, which guarantees conflict-free and minimum jitter communication. Best-effort messages (BE-messages) are transmitted as regular Ethernet messages in the time intervals where communication channels are idle and thus do not interfere with scheduled critical traffic. To achieve this, TTEthernet specifies a network-wide fault-tolerant clock synchronization algorithm [4] that guarantees the time synchronization of each participating node.

B. Run-Time System

Real-Time Operating Systems (RTOS) provide the basis for the deterministic execution of tasks with real-time requirements. Typical task constraints include periodic execution and deadlines. Additional constraints appear when distributed applications communicate over deterministic network architectures like TTEthernet. In this particular case, constraints are also related to the network schedule of incoming and outgoing messages. In such scenarios, the end-to-end latency is composed by the inherent delay due to communication as well as that introduced in the execution of tasks. Minimal end-to-end latency is only ensured if the tasks in the end-systems are scheduled with a tight dependency to the incoming or outgoing messages consumed or, respectively, produced.

TT-RTS is an embedded real-time run-time system designed and implemented by TTTech currently undergoing certification (SIL-2) and deployment activities in the scope of multiple cross-industry projects. Within TT-RTS we differentiate two classes of tasks, TT-tasks (time-triggered tasks) and BE-tasks (best-effort tasks). This matches the main message types found in TTEthernet. We consider a discrete time-line based on macroticks, which is the granularity at which the TT-RTS operates. Moreover, we define the schedule based on time slots, where a time slot consists of one or more contiguous macroticks. TT-tasks have a fixed activation time and a dead-line, and are scheduled offline with fixed guaranteed time slots. Within their time slots they cannot be preempted by any other task. However, a TT-task may be scheduled on several discontinuous slots if required (i.e allowing preemption). BE-tasks are preemptive tasks with a fixed time budget. They are treated as background tasks [5, p. 110] without a fixed activation time or deadline, i.e., they run whenever TT-tasks are not executed. Since TT-RTS guarantees temporal isolation between TT- and BE-tasks, we will disregard BE-tasks in the discussion from now on and concentrate on TT-task scheduling.

The schedule for a task set in TT-RTS is specified through a static offline-computed schedule table consisting of a set of time slots, which are either assigned a TT-Task or marked for the execution of BE-Tasks. Since such tables are potentially infinite we incorporate the concept of schedule cycle, which represents the shortest time interval after which the sequence of time slots repeats (i.e. hyperperiod).

C. Task Model

A TT-task TTi is defined by a tuple (Cᵢ^{TT}, Tᵢ^{TT}), where Cᵢ^{TT} is the worst-case computation time (WCET) and Tᵢ^{TT} is the period. In FIG. 2 we show the dependency of TT-tasks with respect to the timing of scheduled TT-messages. Note that the TT-RTS and the network operate on different time-domains. In the upper part of the figure, a scheduled incoming TT-message min needs to be consumed by task TTc while task TTp must produce the payload for an outgoing TT-message by its scheduled window—shown as mout. However, the task and network schedules run in non-synchronized time-domains, which causes TTc to start execution before min has arrived, and TTp to produce the message after it is expected for transmission. In both cases, the effective consumption and production of the messages may only happen in the following task activation, hence increasing the effective end-to-end latency by one task period. The lower part of the figure depicts the same scenario under synchronized time domains and a task schedule enforcing minimum latency with respect to the TT-messages. In this case, both messages are consumed and respectively produced by the expected time. Note that, we consider a model in which the TT-tasks have the same periods as the TT-messages they depend on.

We observe the following fundamental classification of TT-tasks with respect to their network dependencies:
Producer TT-tasks generate TT-messages that must be available by the instant the associated transmission-window in the network schedule starts. We define the producer latency as the time between the TT-task completion and the beginning of the reserved network.
Consumer TT-tasks must consume an incoming TT-message and therefore only start after the associated reception-window. We define the consumer latency as the time from the end of the time-window until the completion of the respective task.
Consumer then Producer TT-tasks have dependencies upon two TT-message time-windows and are a combination of the aforementioned types. This class usually maps to tasks running control loops which consume sensor measurements and produce actuator values.
Free TT-tasks are independent of the TTE-network.

Note that we do not consider the case of producer then consumer as it introduces a fundamental contradiction, i.e., in order to produce the payload for the first message with minimum latency, the task must execute before the transmission of the first message is due. However, the consumption of the second message with minimal latency requires the task to execute after the reception of the later arriving message. Therefore, the order of the messages conflict with respect to the chances of obtaining minimum latency for the task. To solve this, we propose that in these scenarios, the system designer shall decide between either options and effectively define the task as producer or consumer. Thus, the problem is reduced to minimizing the latency for either the consumption or the production of one single message, but not both.

### IV. Offline Scheduling

In this section we start from a generic model without explicit constraints on tasks and define a general task set transformation (Section IV-A) allowing us to construct an optimization approach which generates feasible task sets under EDF (Section IV-B). We then extend the optimization problem to include task interdependence (Section IV-C) and show how dependencies to the network schedule can be solved in a flexible manner in Section IV-D.

A. Task Set Transformation

We first refer to the periodic task model from [6]. Consider a set of n periodic tasks, Γ={τi|1≦i≦n}. A task τi is defined by the tuple (φᵢ, Cᵢ, Tᵢ, Dᵢ) with Cᵢ denoting the computation time, Tᵢ the period, φᵢ the offset, and Dᵢ (for the sake of completeness it is herewith clarified that Di=Dᵢ, Ti=Tᵢ and so forth, thus variables having identical appearance unless the formatting of the subscripted index are identical if not stated otherwise) the relative deadline of the task. The total utilization of Γ is U=Σᵢ₌₁ⁿUᵢ, where

$${U}_{i} = \frac{{c}_{i}}{{T}_{i}}$$

is the utilization of task τi.

We want to transform a task TTi defined through the tuple (Cᵢ^{TT}, Tᵢ^{TT}), into a task τi defined by the tuple (φᵢ, Cᵢ, Tᵢ, Dᵢ). The idea behind this transformation is developed in Section IV-D, for now, we formulate it as follows. The computation times and periods of TT-tasks can be readily transformed, namely, Ci=Ci^{TT} and Ti=Ti^{TT}. Furthermore, we have to assign values for the offsets and deadlines of tasks, where these parameters depend on the specific task properties and requirements. For example, if the TT-task set is independent of network constraints, the offset for each task would be 0 and the deadline would be set equal to its period.

In its most generic formulation, the offset and deadline of a task can take any value that may result in a valid schedule, i.e., φᵢ □[0, Tᵢ−Cᵢ] and Dᵢ □[Cᵢ, Tᵢ]. In order to choose the optimal combination of task offsets and deadlines we introduce the term of task utility that expresses specific task constraints and requirements. We model the task utility using the concept of time utility functions (TUF) [7].

We define two TUF functions, one for the offset and one for the deadline of a task. A TUF for the offset of a task τi is a function defined over the domain [0, Ti−Ci], while the TUF for the deadline is defined over the domain [Ci,Ti]. The TUFs take values in the normalized co-domain [0, 1]. A value of 1 represents maximum utility, whereas 0 denotes an invalid value for the respective parameter, i.e., the resulting schedule is regarded as invalid. Note that TUF functions may constrain the output of the task-set transformation to a sub-domain of the input domain, hence potentially discarding feasible schedules if, e.g. the TUFs for one or more tasks take 0 for any point within their defined domain. In such cases, we claim that the optimality of the transformation still holds, since the TUF introduces additional constraints to the validity of a transformed task set. Note also that TUFs with values greater than 0 do not introduce such constraints. In Section IV-D we elaborate on the mapping of TUFs to specific task constraints and requirements. For now, we regard any function as valid.

B. Optimization Problem

We formulate the problem of finding a feasible task-set (i.e. combination of task offsets and deadlines) that result in the largest possible accrued value of TUFs.

The first set of constraints on the offsets and deadlines come from the feasibility test of EDF [6]. EDF is a dynamic scheduling algorithm which prioritizes task instances based on their absolute deadlines, i.e., at each time instant, the task with the most immediate absolute deadline is scheduled. For task sets scheduled with EDF, a necessary and sufficient schedulability condition has been given in [6], namely, the task set Γ is schedulable such that no absolute deadline is missed if U≦1. The schedulability test, however, is based on deadlines being equal to periods and offsets being 0. For our purposes, we have to look at a task model in which the arrival times have an offset φᵢ>0 and a deadline Di≦Ti [5,p. 79]. We therefore apply the necessary and sufficient feasibility test for asynchronous tasks with deadlines less than or equal to periods from [8], [9]. In essence, we define the optimization problem to explore each combination of task parameters, skipping those that result in non-feasible task sets.

The second set of constraints comes through the previously defined property of TUFs where a value of 0 results in an invalid parameter. Thus, we define the maximization function as the sum of TUFs of all tasks, and the constraints as the aforementioned schedulability conditions for asynchronous tasks with deadlines less than or equal to periods with additional user constraints on non-valid task sets.

Each task τiεΓ is defined, as presented earlier, by the tuple (φᵢ, Cᵢ, Dᵢ, Tᵢ). We denote the time utility functions of a task τᵢ with TUFᵢ^{φ}: [0, Tᵢ−Cᵢ]→[0, 1], and TUFᵢ^{D}: [Cᵢ, Tᵢ]→[0, 1], for offset and deadline, respectively. We use the definitions from [9], namely, H=1 cm{T₁, . . . , Tₙ}, Φ=max{φ₁, . . . , φₙ} and define E=Φ+2·H. For each generated task set, the schedulability condition is checked using the necessary and sufficient feasibility test for asynchronous tasks from [8], [9]. We thus define the optimization problem as:

$${max}_{{ϕ}_{i} , {D}_{i}} {TUF}_{Γ} {\sum }_{i = 1}^{n} ( {TUF}_{i}^{ϕ} ( {ϕ}_{i} ) + {TUF}_{i}^{D} ( {D}_{i} ) ) , \\ Subject to \text{:}$$

$${\sum }_{k = 1}^{n} \frac{{C}_{k}}{{T}_{k}} \leq 1$$

$$∀ k ∈ [ 1 , n ] {TUF}_{k}^{ϕ} ( {ϕ}_{k} ) > 0 Λ {TUF}_{k}^{D} ( {D}_{k} ) > 0$$

$$∀ {t}_{1} ∈ Λ , ∀ {t}_{2} ∈ Δ , \\ {t}_{1} < {t}_{2} \text{:} {\sum }_{k = 1}^{n} {{C}_{k} ( ⌊ \frac{{t}_{2} - {ϕ}_{k} - {D}_{k}}{{T}_{k}} ⌋ - ⌈ \frac{{t}_{1} - {ϕ}_{k}}{{T}_{k}} ⌉ + 1 )}_{0} \leq {t}_{2} - {t}_{1}$$

$$where$$

$$Λ {=}^{def} \{ {a}_{i , j} = {ϕ}_{i} + {jT}_{i} \vert i = 1 , … , n : j \geq 0 ; {a}_{i , j} \leq E \} , \\ Δ {=}^{def} \{ {d}_{i , j} = {a}_{i , j} + {D}_{i} \vert i = 1 , … , n : j \geq 0 ; {d}_{i , j} \leq E \}$$

For each possible solution of a given task set these conditions are derived from the task parameters themselves. The sets A and A contain the arrivals and absolute deadlines, respectively, of all jobs until the time instant E. These two sets create intervals that, according to [8], [9], need to fulfill the condition that the processor demand is less than the processor capacity, i.e., the amount of work done by the jobs in an interval is less than or equal to the length of the interval.

C. Task Interdependencies

In real applications task dependencies are found not only with respect to network messages but also with respect to other tasks. Task interdependencies are usually expressed as precedence constraints [10], e.g., task τi must execute and finish before task τj starts. Note that we consider only simple precedences, as they are called in [11], namely precedence constraints only between purely periodic TT tasks that have the same “rate”. Multi-rate communication among tasks (extended precedences [11]) is left for future work.

In EDF, the precedence constraints between two tasks are guaranteed if the release times and deadlines are set accordingly, i.e., if task τi has to run before task τj, then the release time and deadline of task τj have to be after the release time and deadline of task τi, respectively. It can be easily proven (cf. [5, p. 71]) that if the original task set is modified to include precedence constraints in the form of altering release times and deadlines then the algorithm is still optimal. For the particular case of two or several tasks having the same deadline at a given time instant of time, EDF does not define an explicit criteria to choose among them. Nevertheless, the algorithm can be extended to include priorities for tie-breakers between tasks without altering the scheduling optimality [6]. Therefore, we adopt the following criteria to define task priorities: If task τi with priority Pi and τj with priority Pj with Pi>Pj have the same deadline at time t, task τi will be executed first.

We model task interdependence as additional constraints in the optimization problem formulation from Section IV-A, which guarantee that applying the EDF scheduling algorithm will result in a static schedule that satisfies these dependencies. If task τi has to run before task τj the additional constraint can be formulated as φᵢ≦φⱼ, Dᵢ≦Dⱼ, Pᵢ>Pⱼ.

The schedulability proof is trivial (see for example the proof for the simple case in [5, p. 71]) since all modified parameters are either greater or equal (in case of offsets) or smaller or equal (in the case of deadlines) than their original counterparts. From [5, p. 71] we know that if the modified task set is schedulable, then also the original one is schedulable and the tasks respect their initial deadlines, but, in addition, they also adhere to the precedence relations.

D. Network Schedule Dependencies

In Section III-C we identified four types of tasks, namely producer, consumer, consumer then producer, and free TT-tasks in terms of their network dependencies. Our goal is to minimize the producer and consumer latencies by finding values for task offsets and deadlines accounting for the network dependencies. Free tasks can be scheduled anywhere since they do not have dependencies to the network schedule while the other type of tasks need to be scheduled such that the latency between the consumption or production and the moment of sending or receiving of the TT-message is minimized.

We start from a restrictive transformation with minimal producer and consumer latencies by adapting the task model transformation described in Section III-C as follows:

1. Set deadlines and computation times, Ci=Ci^{TT}, Ti=Ti^{TT}.

2. The type of TT-Task determines which parameters are constrained by the network schedule: For producer TT-tasks the computation must be completed before the dependent TT-message transmission is due. Therefore, its deadline is fixed at the beginning of the transmission-window. Analogously, for consumer TT-tasks, the arrival time is fixed at the end of the reception-window. For consumer then producer TT-tasks both arrival and deadlines are fixed by the end of the reception-window of the consumed TT-message and respectively at the beginning of the transmission-window of the produced TT-message. For free tasks, the offset is equal to 0 and the deadline is set to be equal to its period.

3. To complete the transformation with minimal producer and consumer latencies we fix the remaining parameters as follows. The offset of a producer TT-task TTᵢ is φᵢ=Dᵢ−Cᵢ and the deadline of a consumer TT-task TTⱼ is set to Dⱼ=φⱼ+Cⱼ.

With this transformation we obtain a single solution that is also optimal if the task set is feasible through EDF. Hence, the optimization problem is reduced to a simple schedulability check. This method guarantees minimal producer and consumer latencies at the expense of introducing strict task constraints. That is, with exception of the free task all other TT-tasks are in effect non-preemptable (i.e. the time left between their release and deadline equals their computation time).

If we allow for less restrictive input domains, we can map the rigidity of a task in terms of increasing its latency to TUF functions, i.e., we may find a feasible schedule by increasing the schedulability time-window (i.e. the time interval in which a task may be scheduled) for selected tasks. For example, for a consumer task the requirement might be that it only has to run after the message is received but there is a certain flexibility with respect to delaying its execution (e.g. the utility decreases linearly as the latency increases). In order to define the input domains matching the task dependencies to the network schedule, we introduce additional constraints for offsets and deadlines in the optimization problem. Note that, restricting the input domain of a TUF function is equivalent to adding constraints on the specific variable for the optimization problem and vice-versa.

We define the critical time instant tᵢ^{p} for a producer task τᵢ as the transmission time of the associated TT-message. Analogously, tᵢ^{c} denotes the end of the reception-window for the TT-message associated with a consumer task τᵢ. For a producer TT-task τᵢ the deadline of the task can be no later than its critical instant, hence, we add a constraint for the optimization problem that guarantees that the task will not exceed its critical instant, namely Cᵢ≦Dᵢ≦tᵢ^{p}. For the offset we also introduce an additional constraint, namely 0≦φᵢ≦Dᵢ−Cᵢ. This is equivalent to restricting the input domain of the task deadline TUF is reduced to [Cᵢ, tᵢ^{p}] and the offset TUF domain to [0, tᵢ^{p}−Cᵢ]. If the task has no dependencies to other tasks, the input domain for the deadline TUF can be further restricted to just {tᵢ^{p}}, thus allowing maximum flexibility for EDF by extending the task's schedulability region to its maximum. Clearly, in this case, having a deadline that is smaller than the critical instant would not result in a better schedule.

Analogously, for a consumer TT-task τᵢ, an additional constraint on the offset is tᵢ^{c}≦φᵢ≦Tᵢ−Cᵢ and φᵢ+Cᵢ≦Dᵢ≦Tᵢ on the deadline. This is equivalent to restricting the input domain of the offset TUF to φᵢ □[tᵢ^{c}, Tᵢ−Cᵢ] while the deadline TUF domain becomes [tᵢ^{c}+Cᵢ, Tᵢ]. Similar to producer tasks, if there are no other dependencies we can reduce the input domain of the offset TUF to {tᵢ^{c}}.

For consumer then producer TT-Tasks we consider three possible cases, although we acknowledge that other cases may exist depending on the system particularities.
i) The task must consume the TT-message with minimum latency (e.g. command: switch to safe-mode) and then produce a non-critical acknowledgment.
ii) The task receives a command to process data and transmit it with minimum latency (e.g. most recent sensor value).
iii) Both consumption and production of the TT-messages require minimum latency (e.g. data acquisition and feedback for a control loop).

We decide the input domains for the TUF of each case as follows: in case i) the task is treated as a consumer since the production is not critical. Inversely, ii) is treated as a producer, given that the consumption is not critical. Case iii), on the other hand, has conflicting requirements that cannot be completely satisfied. Therefore, we define the input domains as [tᵢ^{c}, tᵢ^{p}−Cᵢ] and [tᵢ^{c}+Cᵢ, tᵢ^{p}], respectively.

A free TT-task implies no additional constraints on the optimization problem. Therefore, a free task that is also independent of other tasks can have a fixed offset of 0 and a deadline equal to Ti. It is still possible, however, to define through the input domains and TUFs that a free task has other types of dependencies (e.g. a specific offset in the schedule cycle) and therefore the input domains (or additional optimization constraints) can be chosen accordingly.

If we consider network dependencies as well as inter-task dependencies, we need to add both the additional constraints presented in section IV-C and the aforementioned constraints on network dependent tasks. Through this we obtain input domains for the TUFs of tasks that will only allow values for offsets and deadlines resulting in compliant task sets that respect both inter-task and network dependencies.

As can be seen, the TUF input domains are reduced (in some cases even to single points), which decreases the size of the solution space. The choice of TUFs depends on the individual TT-task requirements. A system designer can thus specify for example that the utility of a certain task decreases when its latency increases or has maximum utility only in a sub-domain of the input domain. We expect the TUFs to be monotonic although they need not be. Hence, the TUF allows each task to have a very flexible definition of latency requirements and can map to any scenario found in industry. We intentionally leave aside the discussion regarding TUFs for particular systems for now, arguing that our approach is independent of this aspect. In Section V-A we will give examples of input domains and TUFs for tasks running in a real-world industrial application.

E. Schedule Generation

If a task set is found by solving the optimization problem, the static schedule is generated by running an offline simulation of the EDF algorithm on that task set. The properties of EDF [5, p. 57] allow us to claim that the generated schedule is optimal with respect to minimizing maximum latency. On the other hand, if no schedule is found using EDF then no other algorithm can find a feasible schedule. The TUF paradigm quantifies the utility of each task, hence, the resulting static schedule is optimal with respect to the accrued utility of all tasks. Moreover, the resulting schedule is guaranteed to also respect the network dependencies as well as task inter-dependencies as defined in Section IV-D and IV-C, respectively. By using EDF to generate the static schedules we effectively reduce the search space since we do not consider all task inter-leavings, i.e., all possible placements and preemptions for the task set, but limit the search to combinations of feasible task offsets and deadlines and let EDF generate the final schedule. Moreover, the restricted input domains for offsets and deadlines further reduce the required search space in the optimization problem.

### V. Industrial Case Experience

A. Project Description

We take as a reference project TTE-IND, which triggered the development of TT-RTS for a large industrial development of ACME Corp. The project is currently in an advanced phase of development and has successfully fulfilled several intermediate test and integration phases.

The network topology of the industrial application consists of 4 pairs of TTE-switches (in total 8 switches) and up to 80 TTEthernet end-systems (nodes) connected to the switches (70 end-systems with communication speed of 100 Mbit/s and 4 with 1 Gbit/s). The communication speed between switches is 1 Gbit/s. The 100 Mbit/s end-systems communicate with 1 Gbit/s nodes and vice-versa via time-critical TT-messages that contain safety-critical payload. Diagnostic messages sent between end-systems and switches are sent through best-effort or rate-constrained messages. Each TTEthernet end-system has at its core a TMS570 MCU (certified up to IEC61508/SIL3) from Texas Instruments equipped with an ARM Cortex-R4F processor (and an additional processor in lock-step with error detecting logic) running at 180 MHz.

B. Test Setup

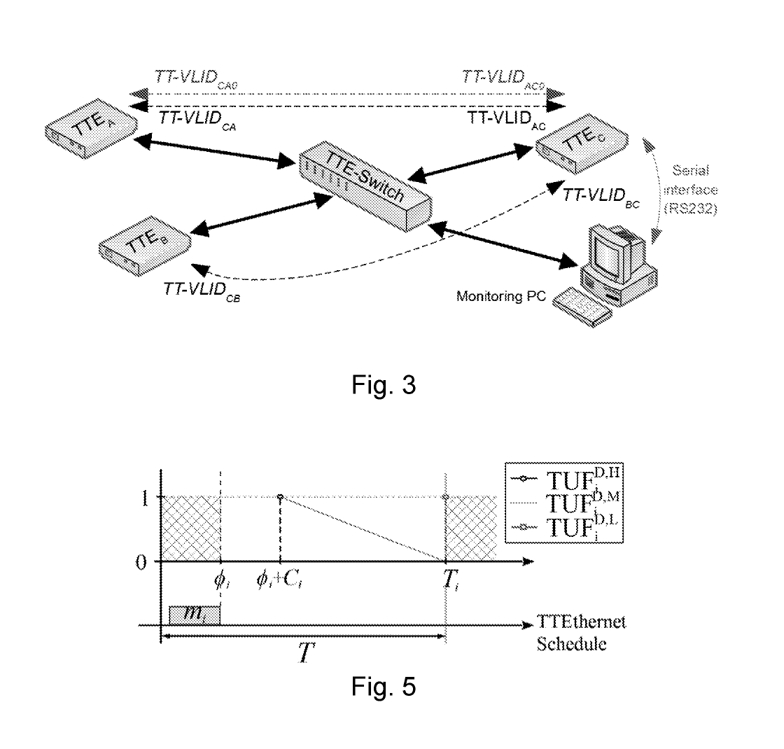

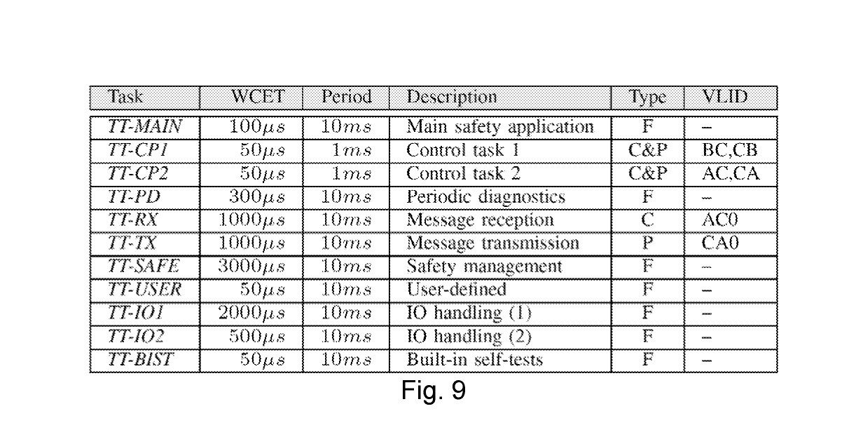

For testing purposes we have an internal test setup where we conduct our performance and integration tests. The test-bed (seen in FIG. 3) consists of 1 TTE-switch connected with 3 TTEthernet end-systems (TTE-A, TTE-B, TTE-C), as described above, running TT-RTS. Additionally, there is 1 PC which monitors network communication through the switch monitoring port and also provides a serial connection to one of the end-system for console output. On each of the 3 end-systems there are 11 TT tasks, as listed in FIG. 9. Out of them, 7 are free (F) tasks and 4 have dependencies to TT-messages (VLID). On end-system TTE-C, which we use as a reference for our experiments, task TT-RX is a consumer task (C) with dependency to TT-message with VLID AC0 while task TT-TX is a producer task (P) with dependency to VLID CA0. Tasks TT-CP1 and TT-CP2 are consumer then producer tasks (C&P) with dependencies to VLID pairs (BC,CB) and (AC,CA), respectively. As these are the main control tasks, defined by a tight period of 1 ms, they consume sensor data and produce actuator values. The system also contains BE tasks (not shown) performing network functions like SNMP and ICMP servers as well as logging among others. Equivalent TT-tasks running on different end-systems need to have minimal end-to-end latency and low jitter while the BE-tasks do not have any timing requirements.

We introduce three types of rigidity for TT-tasks, namely High-, Medium-, and Low-rigidity. These rigidity classes map to the different task latency requirements identified for the presented industrial application. In this test-bed we do not have inter-task dependencies. Therefore, we take the input domains for the TUFs of tasks that have been defined in Section IV-D. For the offset TUF, the input domain remains {tᵢ^{c}}, where tᵢ^{c} is the critical time instant for the consumer task. Moreover, TUFᵢ^{φ}(tᵢ^{c})=1. We define our set of deadline TUFs for consumer tasks as shown in FIG. 5, that is:
For high rigidity tasks, the deadline TUFᵢ^{D,H} input domain is {φᵢ+Cᵢ} and TUFᵢ (φᵢ+Cᵢ)=1. Hence, high rigidity tasks can only be scheduled with minimal latency.
For medium rigidity tasks, the deadline TUFi^{D,M} value decreases linearly between the critical time instant and the end of the period, hence the input domain is [φᵢ+Cᵢ, Tᵢ].
For low rigidity tasks, the deadline TUFi^{D,L} input domain is {Tᵢ} and TUFi^{D,L}(T₁)=1. Hence, for low rigidity TT-tasks we give the maximum flexibility for EDF to schedule the task. The analogous case can be made symmetrically for the TUFs of a producer task, in which the critical time instant is set as the deadline of the task—fixed by the beginning of the TT-message transmission window—minus its WCET.

C. Schedule Generation

We have designed and implemented a tool for the generation of static schedules based on the approach discussed in this paper. The tool takes as inputs the TTEthernet network schedule together with user-defined TT-tasks as well as their dependencies to TT-messages and performs the task set transformation as defined in Section IV-A. The offsets and deadlines of the resulting EDF task set are expressed in form of input domains as discussed in Section IV-D. These intervals are used to generate the constrained optimization problem. When the optimal combination of task properties is found, the tool simulates the resulting EDF schedule until the hyperperiod and outputs the result in form of a TT-RTS schedule configuration.

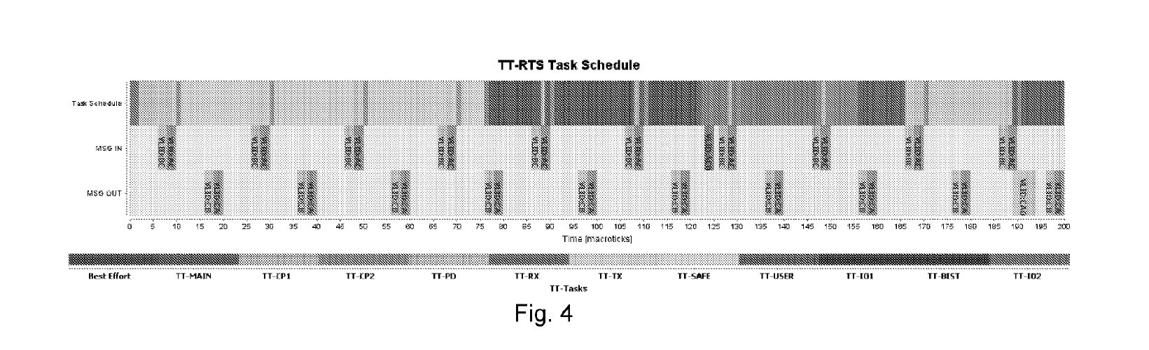

For the system described in Section V-B we obtain a CPU utilization of 90% for TT-tasks while the rest of the CPU is used for BE-tasks. The tight real-time requirements of the tasks combined with high system utilization result in a difficult scheduling problem. Moreover, if one would enumerate all possible schedules and choose the ones that satisfy the constraints (similar to classical approaches), the solution space would be very large. The solution space for one end-system using our method contains 9690 possible task sets (i.e. combinations of task properties) mainly due to the medium rigidity tasks TT-TX and TT-RX. Using our tool, the generation of the static schedule takes 1920 ms. FIG. 4 shows the generated schedule for end-system TTE-C. The macrotick length is 50 μs and the schedule cycle length is 200 macroticks. Tasks TT-TX, TT-RX, TT-CP1, and TT-CP2 which have dependencies to the TT-messages with VLIDs CA0, AC0, BC and CB, AC and CA, respectively, are scheduled such that the latency is minimized while the other TT-tasks are scheduled such that their deadlines are met.

D. Implementation Remarks

During the development and deployment of TT-RTS we identified several issues, of which some are worth additional remarks. On one hand, the overhead of TT-RTS has a direct impact on the optimality at run-time of the generated schedule (Section V-D1). On the other hand, since task dispatching and network communication occur in different time-domains, it is necessary to guarantee precise time synchronization between the run-time system and the TTEthernet network. To this extend, we take into account inaccuracies of the synchronization and try to minimize their impact (Section V-D2) with regard to the end-to-end properties.

1) Scheduler overhead: The overhead that a TT-task experiences at run-time comes from the overhead of saving and restoring the context of a task, servicing the periodic timer interrupt for the logical macrotick, and handling the internal data structures of the offline schedule. We denote the worst case overhead experienced by a task on each macrotick by 6. Given the computation time C^{TT} of TT and the macrotick length mT, we incorporate the scheduler overhead (similar to [12]) by computing the WCET of the corresponding transformed task as

$${C}_{i} = {C}_{i}^{TT} + ⌈ \frac{{C}_{i}^{TT}}{mT - δ} ⌉ δ$$

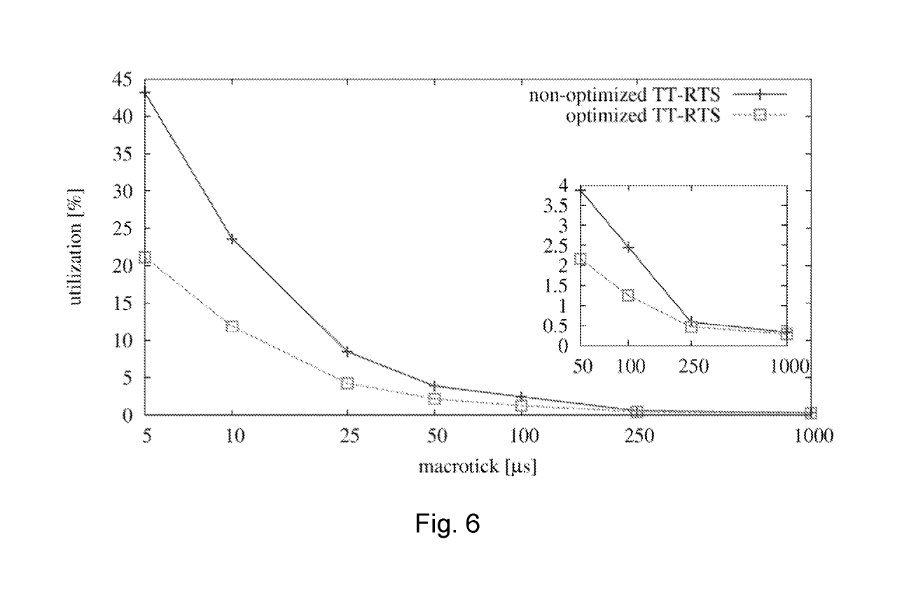

Our implementation of the TT-RTS scheduling algorithm is O(1) with respect to the number of TT- and BE-tasks, however our experience has shown a variation of the scheduling overhead between 400 ns and 4 μs, depending on the scheduling decision and the internal state of the system. FIG. 6 depicts the average global TT-RTS overhead as a percentage of the total CPU bandwidth with respect to the macrotick length. The numbers were obtained measuring the time spent in the TT-RTS routines on one end-system executing the schedule described above with task WCETs scaled based on the macrotick length.

2) Synchronization of TT-RTS to TTEthernet time: We synchronize the TT-RTS schedule cycle to the TTEthernet cycle (TTE-cycle) using rate correction. Specifically, the duration of the macrotick can be modified for a specified interval (called synchronization interval) in order to align the TT-RTS cycle to the TTE-cycle. Within the synchronization interval only BE-tasks are allowed to run since, otherwise, any variation in the length of a macrotick may lead to deadline misses of TT-tasks.

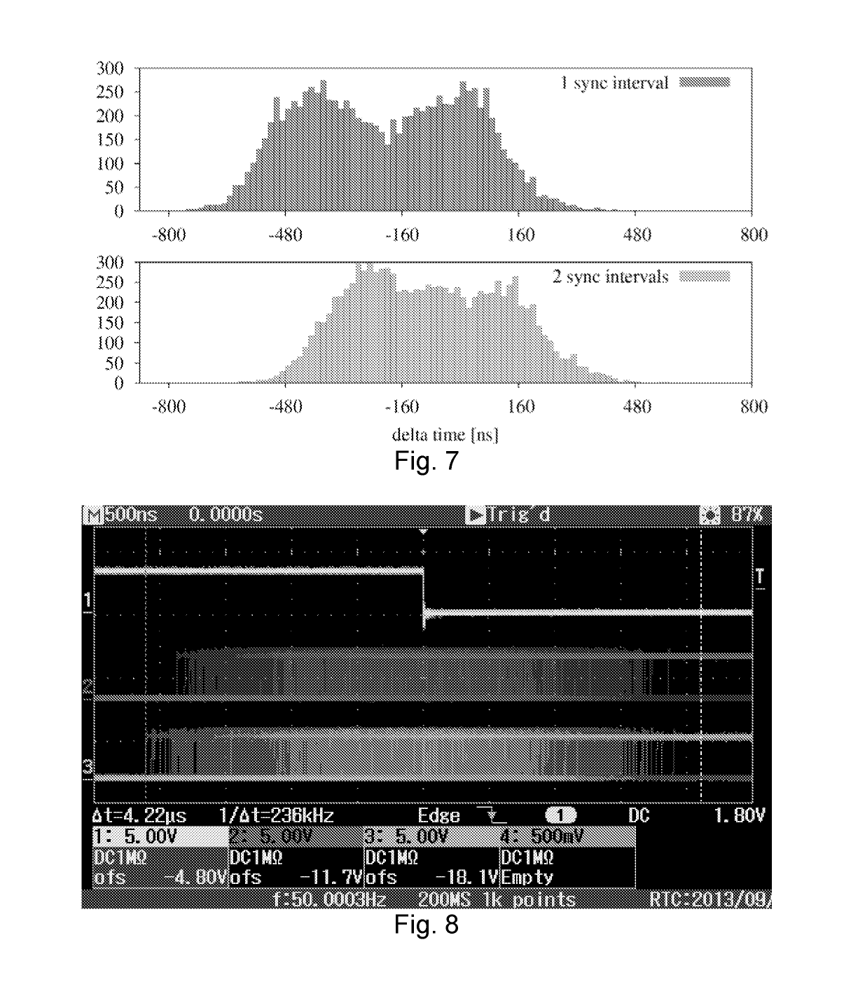

In FIG. 7 we present an experiment conducted with the above setup where we measured the difference between the TT-RTS and the TTEthernet network time over 10000 cycles. In the upper part of the figure we have 1 and in the lower part 2 synchronization intervals, each of length 2 macroticks. The maximum observed error in the first run was 776 ns while the synchronization jitter was around 248 ns on average. In the second run with two synchronization intervals, the maximum observed error was 604 ns and the average error was 188 ns.

We accommodate for this jitter by introducing a fixed parameter to the offset of consumer tasks and to the deadline of producer tasks. Let γ be the synchronization jitter, tᵢ^{c} and tᵢ^{c} are the beginning of a produced and the end of a consumed TT-message, respectively, and tasks τᵢ and τⱼ are the two associated TT-tasks. We can thus write that Dᵢ=tᵢ^{p}−γ and φⱼ=tⱼ^{o}+γ. For consumer then producer tasks we increase the required interval between the two messages by the synchronization jitter.

E. System Tests

Using the test setup described in Section V-B we have conducted an end-to-end precision experiment where we measured the maximal cumulated error of the synchronization. We have instrumented each end-system to trigger an I/O pin when the task TT-USER is executed and measured the trigger using an oscilloscope. We performed an overlay of the measurements on top of each-other using the oscilloscope for each end-system with TTE-A as a reference trigger (FIG. 8). The maximum difference between any two triggers on any two end-systems was 4.22 μs over a measuring period of 30 min. Note that the presented upper bound is computed between any two measurements due to the limitations of the measuring instrumentation. The actual upper bound on the precision may be significantly lower if we consider the difference between any two end-systems for the same measurement.

### VI. Related Work

The scheduling of task sets with dependencies has been studied for many years by different authors. Task inter-dependencies are solved in [10] by modifying the offsets and deadlines of tasks and then using EDF to schedule the new task set [5, p. 71]. In [13] the notion of absolute and relative timing constraints are introduced which are similar to our producer and consumer requirements. In [14] the iterative deepening method, enhanced with a heuristic function that reduces runtime at the expense of optimality, is used for scheduling periodic tasks that communicate through protocols with bounded transmission times. Follow-up work [15] combines the offline method with a runtime dynamic mechanism to schedule aperiodic tasks. For fixed-priority systems, the work in [16] presents an analysis of the schedulability of tasks that communicate using the TDMA protocol. Several scheduling approaches for communicating tasks have been presented in [17] and [18] that are based on optimization problems. These approaches deal with precedence relations among tasks (regardless if they arise from communication or not) whereas we look at explicit task dependencies to a predefined network schedule.

### VII. Conclusion

We have presented a generalized method extending the deterministic paradigm of TTEthernet towards the software layers, allowing the execution of real-time distributed applications with end-to-end guarantees. Our work is aimed at generating optimal static time-triggered schedules for user-defined task sets with guaranteed minimal end-to-end latency. We have provided means to express task dependencies to an existing TTEthernet communication schedule as well as inter-task dependencies as a constrained optimization problem minimizing the end-to-end responsiveness towards scheduled messages. Our approach uses mechanisms from dynamic priority scheduling to effectively reduce the solution space without loss of optimality. The presented process and tools are currently on deployment in large industrial applications as the one we have introduced in this paper.

### REFERENCES

[1] W. Steiner, G. Bauer, B. Hall, and M. Paulitsch, “TTEthernet: Time-Triggered Ethernet,” in Time-Triggered Communication, R. Obermaisser, Ed. CRC Press, August 2011.
[2] Issuing Committee: As-2d2 Deterministic Ethernet And Unified Networking, “SAE AS6802 time-triggered ethernet,” 2011. [Online]. Available: http://standards.sae.org/as6802/[3]
[3] W. Steiner, “TTEthernet specification,” TTA Group, 2008. [Online]. Available: http://www.ttagroup.org
[4] W. Steiner and B. Dutertre, “Automated formal verification of the TTEthernet synchronization quality,” in NASA Formal Methods, ser. Lecture Notes in Computer Science. Springer, 2011, vol. 6617.
[5] G. C. Buttazzo, Hard Real-time Computing Systems: Predictable Scheduling Algorithms And Applications (Real-Time Systems Series). Springer-Verlag, 2004.
[6] C. L. Liu and J. W. Layland, “Scheduling algorithms for multiprogramming in a hard-real-time environment,” Journal of the ACM, vol. 20, pp. 46-61, 1973.
[7] P. Li and B. Ravindran, “Adaptive time-critical resource management using time/utility functions: Past, present, and future,” in Proc. COMP-SAC. IEEE Computer Society, 2004.
[8] S. K. Baruah, L. E. Rosier, and R. R. Howell, “Algorithms and complexity concerning the preemptive scheduling of periodic, real-time tasks on one processor,” Real-Time Syst., vol. 2, no. 4, 1990.
[9] R. Pellizzoni and G. Lipari, “Feasibility analysis of real-time periodic tasks with offsets,” Real-Time Syst., vol. 30, no. 1-2, pp. 105-128, 2005.
[10] H. Chetto, M. Silly, and T. Bouchentouf, “Dynamic scheduling of real-time tasks under precedence constraints,” Real-Time Syst., vol. 2, no. 3, pp. 181-194, 1990.
[11] J. Forget, E. Grolleau, C. Pagetti, and P. Richard, “Dynamic priority scheduling of periodic tasks with extended precedences,” in Proc. ETFA. IEEE Computer Society, 2011.
[12] S. S. Craciunas, C. M. Kirsch, and A. Sokolova, “Response time versus utilization in scheduler overhead accounting,” in Proc. RTAS, 2010.
[13] S. Choi and A. K. Agrawala, “Scheduling of real-time tasks with complex constraints,” in Performance Evaluation: Origins and Directions. Springer-Verlag, 2000.
[14] G. Fohler, “Flexibility in statically scheduled real-time systems,” Ph.D. dissertation, TNF, April 1994.
[15] D. Isovic and G. Fohler, “Handling mixed sets of tasks in combined offline and online scheduled real-time systems,” Real-Time Syst., vol. 43, no. 3, pp. 296-325, 2009.
[16] K. Tindell and J. Clark, “Holistic schedulability analysis for distributed hard real-time systems,” Microprocess. Microprogram., vol. 40, 1994.
[17] T. F. Abdelzaher and K. G. Shin, “Combined task and message scheduling in distributed real-time systems,” IEEE Trans. Parallel Distrib. Syst., vol. 10, no. 11, pp. 1179-1191, 1999.
[18] D.-T. Peng, K. Shin, and T. Abdelzaher, “Assignment and scheduling communicating periodic tasks in distributed real-time systems,” IEEE Trans. Softw. Eng., vol. 23, no. 12, pp. 745-758, 1997.

1. Method for executing tasks in a computer network, wherein said computer network comprises nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages,
characterized in that
said tasks are executed on nodes and/or on the at least one starcoupler according to a static task schedule, wherein said task schedule is computed by the following steps:
a) transforming a defined task set to a periodic asynchronous task model (p1), preferably an EDF task model (p1), yielding a first quantity of task sets;
b) applying a feasibility test (p2) to the first quantity of task sets obtained in step a) for reducing the number of task sets to a second quantity of task sets (s1), a so-called schedulable task sets (s1);
c) applying a precedence test (p3) to the second quantity of task sets obtained in step b), producing a subset of task sets of the second quantity of task sets, said subset of task sets comprising the so-called compliant task sets (s2);
d) applying a criteria (p4) over the set of compliant task sets (s2), resulting in one task set, a so-called “final” task set (s3).

2. Method according to claim 1, wherein a dynamic scheduling algorithm simulator (p5), preferably an EDF simulator, more preferably an offline EDF simulator, generates, based on the final task set (s3), a schedule, the so called final schedule.

3. Method according to claim 1 or 2, wherein in step d) an optimal criteria (p4) is applied over the set of compliant task sets (s2), resulting in one task set, a so called optimal task set (s3).

4. Method according to one of the claims 1 to 3, wherein the task schedule is computed offline.

5. Method according to one of the claims 1 to 4, wherein dependencies with TT-messages for those tasks involved in the production or consumption of payload data are considered during the specification of task parameters.

6. Method according to one of the claims 1 to 5, wherein the static schedule is calculated by taking into account the dependencies of tasks to a network schedule of the computer network.

7. Method according to one of the claims 1 to 6, wherein the static schedule is calculated by taking into account interdependencies of different tasks.

8. Method according to one of the claims 1 to 7, wherein each task set of the compliant task sets (s2) is assigned a utility function, preferably a Time Utility Function (TUF) evaluating the optimality of each possible parameter value.

9. Method for calculating task parameters and/or task schedules in a computer network, wherein said computer network comprises nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages,
characterized in that
said tasks are executed on nodes and/or on the at least one starcoupler according to a static task schedule, wherein said task schedule is computed by the following steps:
a) transforming a defined task set to a periodic asynchronous task model (p1), preferably an EDF task model (p1), yielding a first quantity of task sets;
b) applying a feasibility test (p2) to the first quantity of task sets obtained in step a) for reducing the number of task sets to a second quantity of task sets (s1), a so-called schedulable task sets (s1);
c) applying a precedence test (p3) to the second quantity of task sets obtained in step b), producing a subset of task sets of the second quantity of task sets, said subset of task sets comprising the so-called compliant task sets (s2).
d) applying a criteria (p4) over the set of compliant task sets (s2), resulting in one task set, a so-called “final” task set (s3).

10. Method according to claim 9, wherein a dynamic scheduling algorithm simulator (p5), preferably an EDF simulator, more preferably an offline EDF simulator, generates, based on the final task set (s3), a schedule, the so called final schedule.

11. Method according to claim 9 or 10, wherein in step d) an optimal criteria (p4) is applied over the set of compliant task sets (s2), resulting in one task set, a so called optimal task set (s3).

12. Method according to one of the claims 9 to 11, wherein the task schedule is computed offline.

13. Method according to one of the claims 9 to 12, wherein dependencies with TT-messages for those tasks involved in the production or consumption of payload data are considered during the specification of task parameters.

14. Method according to one of the claims 9 to 13, wherein the static schedule is calculated by taking into account the dependencies of tasks to a network schedule of the computer network.

15. Method according to one of the claims 9 to 14, wherein the static schedule is calculated by taking into account interdependencies of different tasks.

16. Method according to one of the claims 9 to 15, wherein each task set of the compliant task sets (s2) is assigned a utility function, preferably a Time Utility Function (TUF) evaluating the optimality of each possible parameter value.

17. Computer network comprising nodes and optionally at least one starcoupler, wherein said nodes are connected to each other, directly, for example via a bus or a bus system, and/or by said at least one starcoupler and/or by at least one multi-hop network, and wherein in said computer network nodes exchange time-triggered messages,
characterized in that
said tasks are executed on nodes and/or on the at least one starcoupler according to a static task schedule, wherein said task schedule is computed by the following steps:
a) transforming a defined task set to a periodic asynchronous task model (p1), preferably an EDF task model (p1), yielding a first quantity of task sets;
b) applying a feasibility test (p2) to the first quantity of task sets obtained in step a) for reducing the number of task sets to a second quantity of task sets (s1), a so-called schedulable task sets (s1);
c) applying a precedence test (p3) to the second quantity of task sets obtained in step b), producing a subset of task sets of the second quantity of task sets, said subset of task sets comprising the so-called compliant task sets (s2);
d) applying a criteria (p4) over the set of compliant task sets (s2), resulting in one task set, a so-called “final” task set (s3).

18. Computer network according to claim 17, wherein a dynamic scheduling algorithm simulator (p5), preferably an EDF simulator, more preferably an offline EDF simulator, generates, based on the final task set (s3), a schedule, the so called final schedule.

19. Computer network according to claim 17 or 18, wherein in step d) an optimal criteria (p4) is applied over the set of compliant task sets (s2), resulting in one task set, a so called optimal task set (s3).

20. Computer network according to one of the claims 17 to 19, wherein the task schedule is computed offline.

21. Computer network according to one of the claims 17 to 20, wherein dependencies with TT-messages for those tasks involved in the production or consumption of payload data are considered during the specification of task parameters.

22. Computer network according to one of the claims 17 to 21, wherein the static schedule is calculated by taking into account the dependencies of tasks to a network schedule of the computer network.

23. Computer network according to one of the claims 17 to 22, wherein the static schedule is calculated by taking into account interdependencies of different tasks.

24. Computer network according to one of the claims 17 to 23, wherein each task set of the compliant task sets (s2) is assigned a utility function, preferably a Time Utility Function (TUF), evaluating the optimality of each possible parameter value.
